(19) United States
(12) Patent Application Publication
(10) Pub. No.: US 2007/0160301 A1
(43) Pub. Date: Jul. 12, 2007

(54) Method and apparatus for spatial compression scheme

(75) Inventors: Jin Wang, Shanghai (CN); Fons Bruls, Eindhoven (NL); Gang Wang, Shanghai (CN); Li Li, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,215

(22) PCT Filed: Dec. 8, 2004
(86) PCT No.: PCT/IB04/52703

§ 371 Date: Jun. 5, 2006

(30) Foreign Application Priority Data
Dec. 10, 2003 (CN) 20031012253

(51) Int. Cl. G06K 9/46

(52) U.S. Cl. 382/240

(57) ABSTRACT

The present invention provides a method for compressing the video stream with the spatial stratification, firstly, encoding said video stream after drop-sampling to obtain a base stream; then, decoding and rise-sampling said base stream to obtain a reconstructed stream; subtracting the reconstructed stream from said video stream to obtain a residual stream; next, carrying out the edge detection and analysis for said video stream to obtain the gain value of each pixel in the video stream; finally, multiplying said gain value by said residual stream and encoding the obtained result to obtain an enhanced stream. The invention further finely fractionizes the type of each pixel to obtain its corresponding more accurate gain value, thereby further decrease the number of the transmitted data and the transmitting bit rate required by the enhanced layer based on the premise that the quality of mages can be ensured.

### TECHNICAL FIELD

The present invention relates to a video compression method and apparatus, and more particularly, relates to a video compression method and apparatus using spatial scalable compression scheme.

### BACKGROUND ART

Because of the massive amount of data inherent in digital video, the transmission of full-motion, high-definition video signal is a significant problem in the production of high-definition television program. Further, each frame of digital images is still image (also referred to as image) formed from a group of pixel. The amount of these pixels depend on the display resolution of a special system, therefore the amount of raw digital information included in the high-resolution video is massive. In order to reduce the amount of data needed be sent, compression schemes are used to compress the data. Therefore various video compression standards or processes have been established and used in different situation, including MPEG-2, MPEG-4 and H.263.

In many applications, video is available at different resolutions and/or qualities in one stream. Methods to accomplish this technique are referred to as scalability techniques. A kind of scalability technique is referred to as spatial scalable technique. In this technique, a bit-stream may be divided into two or more layers of streams with different resolutions, and these streams may be combined into a single high-resolution signal. For example, the base layer may provide video signal with low quality and low resolution, while the enhancement layer may provide additional information that can enhance the base layer image.

FIG. 1 illustrates a prior art video encoder using the spatial scalable compression scheme. The technical scheme was disclosed in the international application document with the international publication No. WO 03/036979 A1 (International filling date: 16 Oct. 2002). The disclosure is incorporated herein by reference.

A high-resolution video stream is fed to a low-pass filter 112 to be down-sampled, then the down-sampled stream is coded by the encoder 116 so as to obtain a base stream.

After decoding, the base stream is fed to a up-sampling means 122 to be up-sampled, and a reconstructed stream is obtained. The reconstructed stream, together with said high-resolution video stream, is fed to a subtraction means 132. The subtraction means 132 subtracts the reconstructed stream from said high-resolution video stream, and a residual stream is obtained.

Said high-resolution video stream is also fed to a image analyzer 142, which analyzes every pixel in the video stream in order to obtain a gain value. The gain value tends to be 0 in the image regions with few detail contents and to be 1 in the image regions with many detail contents.

These gain values together with the residual stream are fed to a multiplier 152. After being multiplied by each other, the pixel values of the pixel become lower in the image region with few detail contents. Therefore, the length of binary bits for the pixel value becomes shorter, so that the product of multiplication contains less data compared to the original residual stream. The product of multiplication is further fed to an encoder 156 to be encoded, so that a enhancement stream is obtained.

The prior art spatial scalable compression schemes still have disadvantages with respect to the precision in analyzing images. For example, in this scheme, some noise in the video stream is given a higher gain value, thus the noise can't be removed. Therefore, a new spatial scalable compression scheme is needed, which can analyze the image more precisely so that the amount of data in said enhancement stream can be reduced further.

### SUMMARY OF THE INVENTION

The present invention improves the technical scheme mentioned above, and analyzes the image more accurately, so that the data in the enhancement stream is further decreased.

The present invention provides a method for video stream compression with spatial scalable compression scheme. Firstly, encoding said video stream after drop-sampling to obtain a base stream; then decoding and up-sampling said base stream to obtain a reconstructed stream; subtracting the reconstructed stream from said video stream to obtain a residual stream; next, carrying out the edge detection and analysis for said video stream to obtain the gain value of each pixel in the video stream; finally, multiplying said gain value by said residual stream and encoding the obtained result to obtain a enhancement stream.

The present invention still provides a method for obtaining the gain value of a pixel in the image using the edge detection and analysis method, and the image is a frame in a video stream. Firstly, obtaining the pixel values of a pixel in the image and the surrounding pixel; next, processing said values according to the edge detecting and analyzing method to determining the edge type of said pixel; finally, obtaining the gain value of said pixel according to the processing result. Said edge type includes edge pixel and non-edge pixel. Said edge pixel further includes horizontal pixel, vertical pixel and diagonal pixel; said non-edge pixel includes smooth pixel and isolated pixel. The gain values are different for different type of pixel.

Based on the prior art schemes, the present invention analyzes the image more accurately, further subdivides each type of pixels to obtain corresponding more accurate gain values, thus it is able to further reduce the amount of data to be sent and decrease the bit rate required by the enhancement layer when the image quality is ensured.

The other objects and advantages of the invention will be apparent from and elucidated with reference to the embodiments described hereafter.

### BRIEF DESCRIPTION OF THE DRAWINGS

The invention will now be described, by way of example, with reference to the accompanying drawing, wherein:

FIG. 1 illuminates a prior art video encoder using spatial scalable compression scheme;

FIG. 2 is a schematic diagram of a encoding system using spatial scalable compression scheme with image edge detection and analysis function according to an embodiment of the invention;

FIG. 3 is a schematic diagram illuminating the pixels in a frame and the locations of a pixel and the surrounding pixels;

FIG. 4 is a schematic flow chart of the spatial scalable compression scheme for performing edge detection and analysis according to an embodiment of the invention;

FIG. 5 is a schematic flow chart of edge detection and analysis according to an embodiment of the invention.

In all the drawings, the same reference numbers denote the similar or same features and functions.

### DETAILED DESCRIPTION OF THE INVENTION

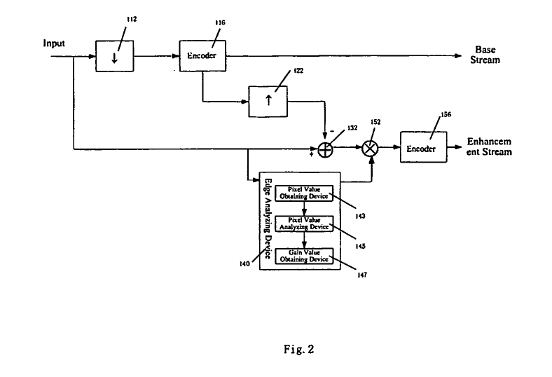

FIG. 2 is a schematic diagram of a encoding system using spatial scalable compression schemes with image edge detection and analysis function according to an embodiment of the invention. The encoding system comprises a base stream creating means 110 for encoding a high-resolution video stream after drop-sampling to obtain a base stream which is a low-resolution stream; a reconstructed stream obtaining means 122 for encoding and up-sampling said base stream to obtain a reconstructed stream which is a high-resolution stream; a residual stream obtaining means 132 for comparing said video stream with the reconstructed stream to obtain a residual stream which is a high-resolution stream; a edge analyzing means 140 for carrying out the edge detection and analysis for said high-resolution stream to obtain the gain value of each pixel in the high-resolution stream; and a enhancement stream creating means 150 for multiplying said gain value by said residual stream and encoding the obtained result to obtain a enhancement stream.

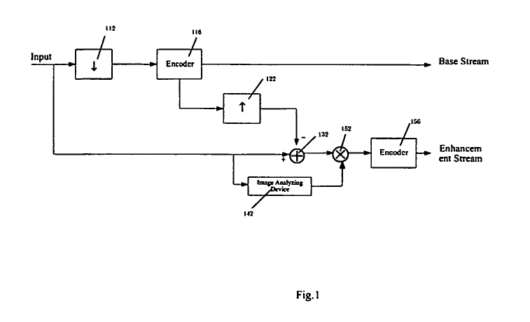

The base stream creating means 110 comprises a low-pass filter 112 and an encoder 116. The low-pass filter carries out the drop-sampling to reduce the resolution of the video stream. The encoder 116 encodes the drop-sampled video stream to obtain a base stream. The low-pass filter 112 and the encoder 116 have the similar or same features and functions as the apparatus with same reference number in the FIG. 1.

The reconstructed stream obtaining means 122 is a up-sampling means 122 with a decoder (not shown) which is used to decode the base stream when carrying out encoding, the decoding process also may be carried out by the encoder 116 (also referred to as local decoding) or carried out by a separate decoder(not shown). The base stream creating means 110 and the reconstructed stream obtaining means 122 may be combined into a reconstructed stream creating means.

The edge analyzing means 140 comprises a pixel value obtaining means 143 for obtaining the pixel values of a pixel and the surrounding pixels in said high-resolution stream; a pixel value analyzing means 145 for processing said pixel values according to the normal edge analyzing method to determine the edge type of said pixel; and a gain value obtaining means 147 for obtain the gain value of said pixel according to the processing result. The flow chart of the edge analyzing means 140 will be described in detail hereafter.

The enhancement stream creating means 150 comprises a multiplier 152 and a encoder 156. The multiplier 152 processes said residual stream using said gain value. The encoder 156 encodes the result output from the multiplier to obtain a enhancement stream. The multiplier 152 and the encoder 156 have the similar or same features and functions as the apparatus with same reference number in the FIG. 1.

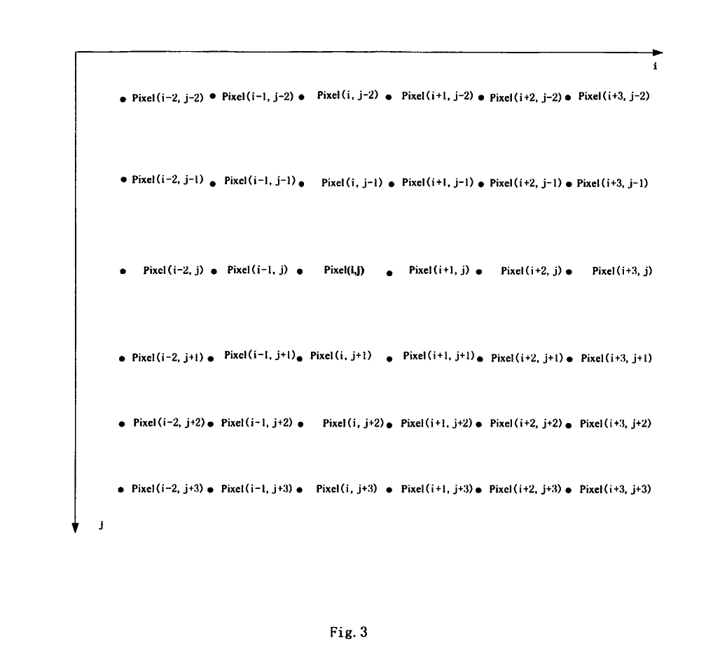

FIG. 3 is a schematic diagram illustrating pixels in a frame of image and the locations of a pixel and the surrounding pixels. In the drawing, the abscissa i denotes the column in which a pixel is located, and the ordinate j denotes the row in which a pixel is located. The drawing shows the location of the pixel (i, j) and the surrounding pixels. The pixel values of the pixels include three kinds: luminance value, chroma value and chromatism value. The luminance value is used to represent the pixel values in the embodiment. Table 1 is the pixel values corresponding to the pixels in the FIG. 3, wherein the pixel value of the pixel (i,j) is 65. The drawing and the values in the table 1 will be referred to in the following description.

TABLE 1
pixel values

| | | | | | |
|---|---|---|---|---|---|
| 47 | 45 | 45 | 45 | 43 | 46 |
| 36 | 35 | 39 | 38 | 34 | 34 |
| 42 | 43 | 45 | 45 | 41 | 42 |
| 67 | 67 | 65 | 63 | 62 | 69 |
| 89 | 94 | 90 | 89 | 83 | 95 |
| 105 | 108 | 98 | 100 | 102 | 110 |
| 116 | 119 | 105 | 101 | 108 | 120 |

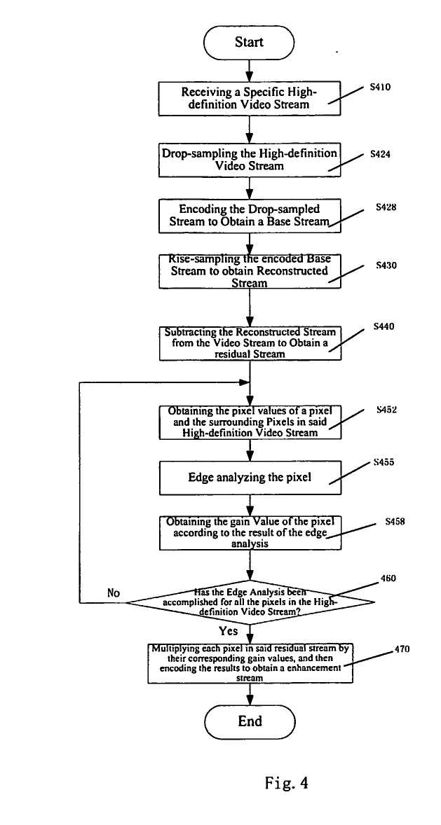

FIG. 4 is a schematic flow chart of the spatial scalable compression scheme carrying out edge detection and analysis according to an embodiment of the invention. Firstly, a specific high-resolution video stream is received (Step S410), for example, a video stream with the resolution 1920*1080i, which high-resolution may be higher than a particular resolution; and said high-resolution video stream is drop-sampled (Step S424). The purpose of drop-sampling is to reduce the resolution, for example, to 720*480i. Then, the drop-sampled video stream is encoded to obtain a base stream (Step S428), in which the encoding is carried out according to MPEG-2 standard. The base stream is a low-resolution stream such as 720*480i.

Next, the decoded base stream is rise-sampled to obtain a reconstructed stream (Step S430), and the reconstructed stream has the similar resolution format, for example 1920*1080i, as the received high-resolution video stream. Then, the reconstructed stream is subtracted from the received high-resolution stream to obtain a residual stream (Step S440). The reconstructed stream has the similar resolution format as the received high-resolution video stream, for example 1920*1080i.

Next, the pixel values of a pixel and the surrounding pixels in the received high-resolution video stream are obtained (Step S452), and the locations of the pixels are shown in the FIG. 3. If a pixel is located on the edge of a frame, the data of the image may be expanded (for example, by the center symmetrical expanding method) to obtain the pixel values of the surrounding pixels. In the FIG. 3, for example, pixel (i,j) is located on the right edge of the frame and the data in the i+1^{th} row, i+2^{th} row and i+3^{th} row does not exist. At the same time, the data in the i−1^{th} row, i−2^{th} row and i−3^{th} row may be copied into the i+1^{th} row, i+2^{th} row and i+3^{th} row. The other situation is similar as this.

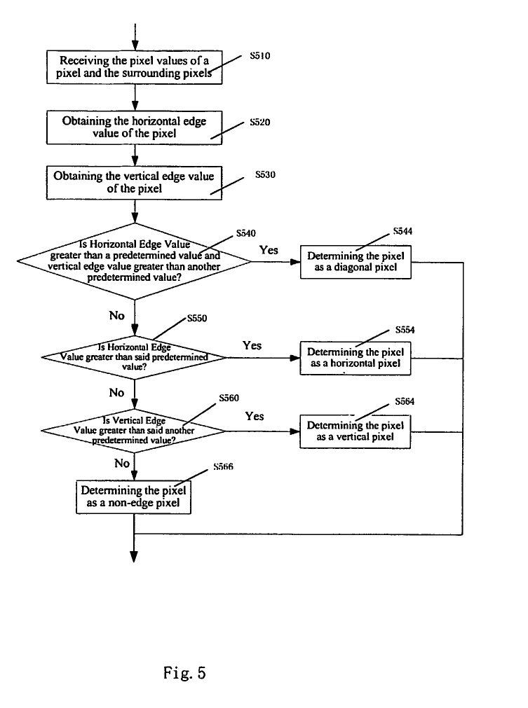

The pixel is edge analyzed according to the pixel values obtained in step S452 (Step S455) to determine the edge type according the edge character. The flow of edge analysis will be described in detail as following (see the FIG. 5). Said edge types include edge pixel and non-edge pixel. Said edge pixel further includes horizontal pixel, vertical pixel and diagonal pixel; said non-edge pixels include smooth pixel and isolated pixel.

The corresponding gain value of the pixel is obtained according to the result of edge analysis in step 455 (step S458). The gain values tend to be 0 in the regions with few detail contents, and tend to be 1 in the regions with many detail contents. And the gain values may be different for edge pixel and non-edge pixel and may be different for the edge pixel of different type. Because the sensitivity of human's vision is different for the image varieties in the different directions. For example, the sensitivity for the varieties in the horizontal direction is more than that in the vertical direction. So the gain values of the horizontal pixel may be set higher.

In addition, if in step S455 the result of the edge analysis for a pixel is a horizontal pixel and the two pixels which adjoin the pixel in the horizontal direction (left, right) are not horizontal pixel, then the pixel is not an employable horizontal pixel and should be sorted out as an isolated pixel. Likewise, if in step S455 the result of the edge analysis for a pixel is a vertical pixel and the two pixels which adjoin the pixel in the vertical direction (up, down) are not vertical pixel, then the pixel is not a employable vertical pixel and should be sorted out as an isolated pixel; if in step S455 the result of the edge analysis for a pixel is a diagonal pixel and the four pixels which adjoin the pixel in the diagonal direction (left up, left down, right up, right down) are neither horizontal pixel, nor vertical pixel or diagonal pixel, then the pixel is not a employable diagonal pixel and should be sorted out as an isolated pixel. In general, the isolated pixel is due to the noise in the process of the video stream production or the errors in the process of encoding and decoding, and it should be removed, so the gain values of the isolated pixels may be set to be 0.

The gain values of each type of pixels may be a numerical range, for example, the gain values range of horizontal pixel is [1.0,0.6], the gain values range of vertical pixel is [0.9,0.5]. For each pixel, the gain values may be chosen from the gain values range of its type according to the edge-dependant pixel variance.

For horizontal pixels, the edge-dependent pixel variance may be calculated as following

$$var ( i , j ) = \frac{\begin{matrix}\vert pixel ( i , j - 1 ) - mean \vert + \vert pixel ( i , j ) - mean \vert + \\ \vert pixel ( i , j + 1 ) - mean \vert\end{matrix}}{3}$$

$$Wherein , \\ mean = \frac{( {\sum }_{q = - 1}^{1} pixel ( i , j + q ) )}{3} .$$

For vertical pixels, the edge-dependent pixel variance may be calculated as following

$$var ( i , j ) = \frac{\begin{matrix}\vert pixel ( i - 1 , j ) - mean \vert + \vert pixel ( i , j ) - mean \vert + \\ \vert pixel ( i + 1 , j ) - mean \vert\end{matrix}}{3}$$

$$Wherein , \\ mean = \frac{( {\sum }_{q = - 1}^{1} pixel ( i + q , j ) )}{3} .$$

For diagonal pixels, the edge-dependent pixel variance may be calculated as following

$$var ( i , j ) = \frac{\begin{matrix}\vert pixel ( i - 1 , j - 1 ) - mean \vert + \\ \vert pixel ( i , j ) - mean \vert + \vert pixel ( i - 1 , j + 1 ) - mean \vert + \\ \vert pixel ( i + 1 , j - 1 ) - mean \vert + \vert pixel ( i + 1 , j + 1 ) - mean \vert\end{matrix}}{5}$$

$$Wherein , \\ mean = \frac{\begin{matrix}pixel ( i - 1 , j - 1 ) + pixel ( i , j ) + \\ pixel ( i - 1 , j + 1 ) + pixel ( i + 1 , j - 1 ) + pixel ( i + 1 , j + 1 )\end{matrix}}{5} .$$

For smooth pixels, the edge-dependent pixel variance may be calculated as following

$$var ( i , j ) = \frac{{\sum }_{p = - 1}^{1} {\sum }_{q = - 1}^{1} \vert pixel ( i + p , j + q ) - mean \vert}{9}$$

$$wherein , \\ mean = \frac{{\sum }_{p = - 1}^{1} {\sum }_{q = - 1}^{1} pixel ( i + p , j + q )}{9} .$$

Finally, whether the edge analysis is accomplished for all the pixels in said high-resolution video is judged. If it hasn't been accomplished, then return to step S452; if it has been accomplished, then multiply the obtained gain values by each corresponding pixels in the residual stream and send the product of multiplying to a encoder 156 to be encoded to obtain an enhancement stream (Step S470), wherein the encoding is carried out according to MPEG-2 standard. Said enhancement stream has substantially similar resolution format as said high-resolution video stream, for example 1920*1080i. Thus, the pixel values of pixels in the regions with few detail content such as non-edge pixels regions become smaller. Therefore, the lengths for the binary bit representation of the pixel values become shorter, so that the result of multiplying contains less data compared to the original residual stream. In particular, all the isolated pixels will be removed so that the amount of data in the enhancement stream is greatly reduced.

Because the residual stream is the difference between said high-resolution video stream and the reconstructed stream, there are a great deal of zeros in the residual stream. Thus, if the edge analysis is carried out for the residual stream, the complexity of calculating will be greatly reduced. Therefore, another choice of the embodiment is that the edge detection and analysis is carried out for each pixels in the residual stream to obtain the corresponding gain values in steps S452 to S458. Of course, the edge detection and analysis also may be carried out for said reconstructed stream to obtain the corresponding gain values of each pixel.

Furthermore, the edge detection and analysis also may be carried out for said high-resolution video stream and the residual stream and the comparison between the results of analysis for each pixels is carried out to determine the type of the pixels to obtain the corresponding gain values in the steps S452 to S458.

FIG. 5 is a schematic flow chart of edge detection and analysis according to an embodiment of the invention. The flow is the further detail of step S455.

Firstly, the pixel values of a pixel and the surrounding pixels which come from the values obtained in step S452 are received (step S510); then, the horizontal edge value of the pixel is obtained (Step S520) and the vertical edge value of the pixel is obtained (Step S530) according to these values.

Next, whether the horizontal edge value is larger than a predetermined threshold value such as 10 and whether the vertical edge value is larger than another predetermined threshold value is judged (Step S540); said two threshold values may be equal or not. If the result of the judgement is yes, then the pixel can be determined as a diagonal pixel (Step S544).

Next, if the result of the judgement is no in step S540, then whether the horizontal edge value is larger than said threshold value is further determined (Step S550). If so, the pixel is determined as a horizontal pixel (step S554).

Finally, if the result of the judgement in step S550 is no, then whether the vertical edge value is larger than said threshold value is further determined (step S560). If so, the pixel is determined as a vertical pixel (Step S564); otherwise, the pixel is determined as a smooth pixel (Step S566).

Taking the pixel (i, j) in the FIG. 3 as an example, the method for calculating said horizontal edge value and vertical edge value is described as following:
Horizontal edge value=|2*{pixel(i+1,j)−pixel(i,j)}+{pixel(i+2,j)−pixel(i−1,j)}+{pixel(i+3,j)−pixel(i−2,j)}|
The horizontal edge value is 7; Vertical edge value=|2*{pixel(i,j+1)−pixel(i,j)}+{pixel(i,j+2)−pixel(i,j−1)}+{pixel(i,j+3)−pixel(i,j−2)}|

The vertical edge value is 169;

Assuming said two threshold values to be 10, then the pixel may be determined as a vertical edge pixel.

While the invention has been shown and described with respect to the particular embodiments, it will be apparent for those skilled in the art that various substitutions, modifications and changes may be made according to to the description hereinabove. Therefore, such substitutions, modifications and changes should be included in the invention when they fall into the spirit and scope of the invention as defined in the appending claims.

What is claimed is:

1. A method for video stream compression with spatial scalable compression scheme, wherein the video stream is a stream with resolution higher than a specific value, comprising the steps of:
a. processing said video stream to obtain a reconstructed stream, wherein the reconstructed stream is a stream with resolution higher than a specific value;
b. comparing said video stream with the reconstructed stream to obtain a residual stream, wherein the residual stream is a stream with resolution higher than a specific value;
c. carrying out the edge detection and analysis for said stream with the resolution higher than a specific value to obtain the gain value of a specified number of pixels in the stream; and
d. processing said residual stream using said gain value to obtain an enhancement stream.

2. The method according to claim 1, wherein step a including the steps of:
encoding the video stream after drop-sampling to obtain a base stream;
decoding and rise-sampling said base stream to obtain said reconstructed stream.

3. The method according to claim 1, wherein said specified number of pixels is all of the pixels.

4. The method according to claim 1, wherein said edge detection and analysis in step c is carried out for said video stream.

5. The method according to claim 1, wherein said edge detection and analysis in step c is carried out for said reconstructed stream.

6. The method according to claim 1, wherein said edge detection and analysis in step c is carried out for said residual stream.

7. The method according to claim 1, wherein step c further comprises:
carrying out the edge detection and analysis for another said stream with resolution higher than a specific value.

8. The method according to claim 1, wherein step c comprises:
obtaining values of a pixel and the surrounding pixels in said stream with resolution higher than a specific value;
processing said values according to a predetermined edge analyzing method to confirm a edge type of said pixel;
obtaining the corresponding gain value of said pixel according to the edge type.

9. The method according to claim 8, wherein said edge type of the pixels includes edge pixel and non-edge pixel.

10. The method according to claim 9, wherein said edge pixel includes horizontal pixel, vertical pixel or diagonal pixel.

11. The method according to claim 9, wherein said non-edge pixel point include the smooth pixel or isolated point.

12. An apparatus for video stream compression with spatial scalable compression scheme, wherein the video stream is a stream with resolution higher than a specific value, comprising:
reconstructed stream creating means for processing said video stream to obtain a reconstructed stream which is a stream with resolution higher than a specific value;
residual stream obtaining means for comparing said video stream with the reconstructed stream to obtain a residual stream with resolution higher than a specific value;
edge analyzing means for carrying out the edge analysis for said stream with resolution higher than a specific value to obtain the gain value of the specified number of pixels in the stream; and
enhancement stream creating means for processing said residual stream using said gain value to obtain an enhancement stream.

13. The apparatus according to claim 12, wherein said specified number of pixels is all of the pixels.

14. The apparatus according to claim 12, wherein said edge analyzing means includes:
pixel value obtaining means for obtaining the values of a pixel and surrounding pixel in said stream with resolution higher than a specific value;
pixel value analyzing means for processing said value according to the predetermined edge analyzing method to confirm a edge type of said pixels;
gain value obtaining means for obtaining the corresponding gain value of said pixels according to the edge type.

15. The device according to claim 14, wherein said edge type includes the edge pixel or non-edge pixel.

16. The device according to claim 15, wherein said edge pixel includes the horizontal pixel, the vertical pixel or the diagonal pixel.

17. The apparatus according to claim 15, wherein said non-edge pixel includes the smooth pixel or the isolated pixel.
